(19) United States
(12) Patent Application Publication
(10) Pub. No.: US 2024/0288336 A1
(43) Pub. Date: Aug. 29, 2024

(54) METHOD AND APPARATUS FOR MOTOR BEARING FAULT DETECTION USING SENSED CURRENT

(71) Applicant: Eaton Intelligent Power Limited, Dublin (IE)

(72) Inventors: Gurmeet SINGH, Maharashtra (IN); Viral SHAH, Surat, Gujarat (IN)

(21) Appl. No.: 18/570,975

(22) PCT Filed: Jun. 9, 2022
(86) PCT No.: PCT/EP2022/025267

§ 371 Date: Dec. 15, 2023

(30) Foreign Application Priority Data
Jun. 17, 2021 (IN) 202111027074
Aug. 2, 2021 (GB) 2111123.2

(51) Int. Cl. G01M 13/045

(52) U.S. Cl. CPC G01M 13/045

(57) ABSTRACT

Methods and apparatus are described to provide notification of a bearing fault in a motor by analysing the motor's current spectrum. Data samples measuring the current drawn by the motor are received from a current sensor. A frequency of the motor supply, speed of the motor and characteristic frequency of the motor are determined. The data samples are processed to produce a frequency spectrum of the current from which it is determined whether any indications of bearing fault are present. These bearing faults are indicated by peaks in the current spectrum corresponding to the characteristic frequencies.

### TECHNICAL FIELD

Various example embodiments relate generally to methods and apparatus for motor bearing fault detection using sensed current.

### BACKGROUND

Bearing failure accounts for a majority of motor faults. When these faults are not detected in time, secondary failures can occur in other motor components like eccentric, winding, etc. which further increases downtime and motor repair costs.

One of the approaches to detect bearing faults, such as point defects, is to use vibration analysis. A vibration sensor is attached to the motor and the sensed vibration signal is analysed to identify bearing faults. The most commonly used bearings in induction motors are ball bearings and roller bearings. The bearing fault related to point defects are easily visible in the vibration signal using characteristic frequencies such as the fundamental train frequency/cage frequency (FTF), ball pass frequency of inner ring/inner race (BPFI), ball pass frequency of outer ring/outer race (BPFO) and ball spin frequency (BSF). A bearing fault is indicated by the presence of any peaks in the vibration signal spectrum around the FTF, BPFI, BPFO and/or BSF frequencies.

Data collection using vibration analysis requires mandatory site inspection, which is to say an engineer needs to inspect the motors. This may not be possible in some cases for safety reasons. Further, collecting vibration data by site inspection is time consuming. The vibration sensors required are very costly and are typically only installed on critical motors.

### SUMMARY

Methods and apparatus are disclosed herein to provide notification of a bearing fault indication without the need for vibration sensors. Vibration and torque pulses arising from a bearing fault, even an incipient fault, lead to changes in the motor's magnetic flux which gets reflected in the motor's current spectrum. The bearing fault frequency components get modulated with the motor's supply frequency and so appear as sidebands around the supply frequency. A current sensor is configured to measure current consumed by a motor, and data samples obtained from the current sensor are processed to determine whether the data samples contain an indication of a bearing fault. This approach has several advantages over the prevailing vibration analysis approach. Many motors already have current sensors to monitor current drawn, so in many cases the installation of current sensors are not required. Data samples from the current sensors can be monitored as requirements dictate, whether continuously or at intervals, since the acquisition of data is not limited to a field inspection from an engineer. Data samples can be analysed remotely from the motor, which may also increase safety.

In a first aspect of the present disclosure, a computer-implemented method is provided, comprising receiving current data samples from a current sensor configured to measure current drawn by a motor, determining a frequency of the supply, determining a speed of the motor, determining a characteristic frequency of a bearing fault, processing the current data samples to obtain a frequency spectrum of the current, determining whether the current frequency spectrum contains an indication of the bearing fault using the supply frequency and the characteristic frequency of the bearing fault, and providing a fault notification according to the determined indication.

In another aspect of the present disclosure, an apparatus is provided comprising a current sensor configured to measure current drawn by a motor, a processor, and a memory. The memory stores instructions which, when executed, cause the processor to perform the method of the first aspect.

In another aspect of the present disclosure, a computer-readable storage medium stores instructions which, when executed by a processor, cause the processor to perform the method of the first aspect.

### BRIEF DESCRIPTION OF THE DRAWINGS

Example embodiments of the present disclosure will now be described with reference to the accompanying drawings, in which:

FIG. 1 shows a method according to embodiments described herein;

FIG. 2 shows a current frequency spectrum of a motor with a bearing fault according to a first example;

FIG. 3 shows a current frequency spectrum of the motor of FIG. 2 with a healthy bearing;

FIG. 4 shows a bearing with defects formed in the inner and outer races according to a second example;

FIG. 5 shows a vibration frequency spectrum of a motor operating with the bearing of FIG. 4;

FIG. 6 shows a current frequency spectrum of the same motor operating with the bearing of FIG. 4; and

FIG. 7 depicts a high-level block diagram of an apparatus suitable for use in performing functions described herein according to some embodiments.

### DETAILED DESCRIPTION

Example embodiments will now be described, including methods and apparatus, to provide notification of a bearing fault indication without the need for vibration sensors by analysing the motor's current spectrum to determine whether any indications of bearing fault (point defect) are present. These bearing faults are indicated by characteristic frequencies. For ball or roller bearings, the characteristic frequencies include:

$$FTF = \frac{S}{2} ( 1 - \frac{B d}{P d} cos ∅ ) \qquad Equation 1$$

$$BPFI = \frac{S}{2} {N}_{b} ( 1 + \frac{B d}{P d} cos ∅ ) \qquad Equation 2$$

$$BPFO = \frac{S}{2} {N}_{b} ( 1 - \frac{B d}{P d} cos ∅ ) \qquad Equation 3$$

$$BSF = \frac{S}{2} \frac{P d}{B d} ( 1 - {( \frac{B d}{P d} cos ∅ )}^{2} ) \qquad Equation 4$$

where S=revolutions per second of the motor (motor speed), Bd=diameter of the balls/rollers in the bearing, Pb=pitch diameter, Nb=number of balls/rollers, and ∅=contact angle between the balls/roller and the inner/outer races of the bearing.

In vibration sensors systems, a bearing fault is identified by peaks in a motor's vibration spectrum at one or more of the above characteristic frequencies. The bearing fault characteristic frequencies get modulated with the motor's supply frequency fs, in the motor's current spectrum. Hence, the bearing fault characteristic frequencies appear as sidebands around fs, as

$${f}_{fb} = \vert fs \pm k * fb \vert \qquad Equation 5$$

where fs is the motor supply frequency, fb is the bearing fault characteristic frequency such as FTF, BPFI, BPFO and BSF above, k is the characteristic frequency harmonic, and fo is the frequency in the motor current spectrum where the characteristic frequency appears.

Embodiments described herein are applicable to motors that are configured as generators to supply current to for example a power grid and to motors that use a supply of current in applications such as pumps, etc. When applied to motors configured as a generator, a skilled person will understand that references in the description below to current drawn by the motor will be instead current supplied by the motor.

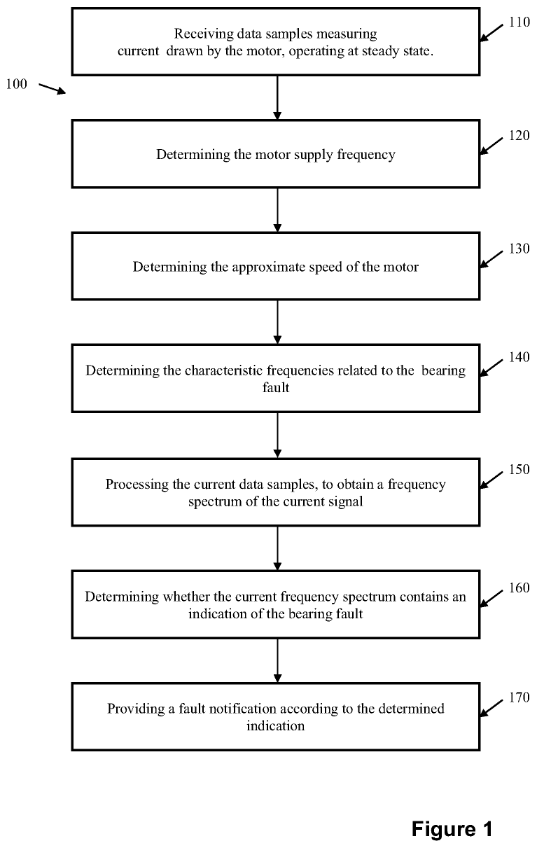

FIG. 1 illustrates an example method 100 according to embodiments described herein. Method 100 may be computer-implemented in some embodiments, as described herein.

As shown in FIG. 1, method 100 comprises, at 110, receiving data samples from a current sensor configured to measure current drawn by a motor. In some implementations only one current sensor is used, for example on one of the motor's three phases. In other implementations two or more current sensors may be used, for example one on each phase of a motor's current supply. The data samples may be received directly from the current sensor, received after transmission over a wired or wireless network, or obtained from a storage medium on which the data samples have been stored.

The method 100 continues, at 120, by determining a frequency of the motor supply, fs. In some implementations, the motor supply frequency, fs, is determined from the data samples using a time-based analysis such as a zero-crossing detector. In other implementations, the motor supply frequency, fs, is determined from the data samples using a frequency-based analysis such as fast Fourier transform (FFT). In some implementations, for instance where the motor is a direct online motor, the motor supply frequency, fs, is fixed and equal to the grid frequency (e.g. 60 Hz or 50 Hz). In implementations where a motor's current use is already monitored, the motor supply frequency, fs, may be received from such a monitoring system.

The method 100 continues, at 130, by determining a speed of the motor, S. Where a motor includes a speed sensor, the speed S may be determined from signals received from the speed sensor or from a monitoring system which determines the speed S. In some implementations, the motor speed S is determined as the motor synchronous speed:

S=2 fs/p Equation 6
where fs is the determined motor supply frequency and p is the number of poles in the motor winding. The number of poles, p, is generally available as a part of a motor's name plate information or may be obtained from a lookup table.

Next, the method 100 continues, at 140, by determining a characteristic frequency, fb, of a bearing fault. The bearing fault (point defects) characteristic frequency, fb, may be any one or more of the FTF, BPFI, BPFO and/or BSF frequencies described above. In some implementations only one characteristic frequency is determined. In other implementations, two, three or all four characteristic frequencies are determined. As is apparent for equations 1 to 4 above, the bearing fault characteristic frequencies fb are a function of the motor speed S and other design parameters that can be regarded as fixed values for a given motor: Bd, Pb, Nb and ∅. In some implementations, the parameters Bd, Pb, Nb and ∅ are obtained from a lookup table. In other implementations, constants calculated from the parameters Bd, Pb, Nb and ∅ are obtained from a lookup table such that each of Equations 1 to 4 is simplified to motor speed S multiplied by a corresponding constant. In other implementations, the bearing fault characteristic frequency fb is obtained from a lookup table using the motor speed S.

Next, at 150, the current data samples are processed to obtain a frequency spectrum of the current supplied by or used by the motor. In one implementation the frequency spectrum is obtained by applying FFT to the data samples. In some implementations, prior to applying FFT, a Hilbert analysis is applied to the data samples to demodulate the motor supply frequency, fs, so that the bearing fault characteristic frequencies appear as offsets from 0 Hz rather than as sidebands around the motor current frequency, fs.

The method 100 then continues, at 160, by determining whether the current frequency spectrum contains an indication of a bearing fault using the supply frequency, fs, and the characteristic frequency, fb, of the bearing fault. Once a bearing fault characteristic frequency fb is determined, the sideband frequencies fo in the motor current spectrum can also be determined from Equation 5 using the motor supply frequency fs. Where a Hilbert analysis or other demodulation technique has been applied to the data samples, the characteristic frequencies will appear in the current spectrum at a demodulated frequency fₕ according to:

$${f}_{h} = \vert ( \vert fs \pm k * fb \vert - fs ) \vert . \qquad Equation 7$$

An indication of a bearing fault will be determined if the current spectrum contains a peak where any of the characteristic frequencies should appear, i.e. at the sideband frequencies f_{fb} if the current spectrum was not demodulated or at demodulated frequency fₕ if the current spectrum was demodulated. In some implementations, a peak within an offset range of where a characteristic frequency is appearing should be taken as an indication of bearing fault to account for any estimated used in determining the characteristic bearing fault frequencies. The offset range is defined by upper and lower range limits, such as an offset of ‘x’ on lower range and ‘y’ on upper range is set. The values of x and y may be integers like 1,2,3, etc. The values chosen for the offset depends upon the proximity of any expected nearby peak, such as peaks related to any other known frequency like broken rotor bar faults, eccentric components, etc. In one implementation, the offset range comprises a −2 Hz lower range limit and a +2 Hz upper range limit, preferably a −1 Hz lower range limit and a +2 Hz upper range limit. In some implementations, step 160 is repeated for a given number of harmonics of each characteristic frequency. The number of harmonics may be a parameter of the method. In some implementations, this step is repeated for each characteristic frequency. In some implementations, a counter is used to record the number of faulty peaks indications determined the counter starting at 0 and being increased by 1 for each peak identified under a particular rotational speed or supply frequency. In some implementations, peaks at the motor supply frequency and eccentric components and their associated harmonics are ignored during the determination. Any suitable peak identification method may be used, for instance by identifying values in the current spectrum that exceed the average values in the surrounding spectrum by more than a predetermined amount.

Next, at 170, a fault notification according to the determined indication is provided if at least one indication was determined. In implementations where a counter is used, a fault notification is provided if the counter value is 1 or higher. In some implementations, a severe fault notification is provided when the number of determined indications is greater than or equal to a threshold, and an incipient fault notification is provided when the number of determined indications is above 0 and below the threshold. The fault notification may be a message in a user interface, a sound or siren, a light on a panel, an SMS or email message, or any combination of these.

In some implementations, method 100 may be implemented as a loop to provide continuous or periodic determination of bearing fault indications in a motor.

### Example 1

The method 100 was applied on an 22 kW induction, motor operated using variable frequency drive. The motor had 4 poles and used deep groove ball bearings with model number 6210. From the manufacturer specifications for the bearing, the BPFI, BPFO, BSF and FTF coefficients were calculated as 5.91, 4.09, 2.66 and 0.41 respectively, such that the characteristic frequencies are simply the motor speed S multiplied by the relevant coefficient.

The motor supply frequency, fs was determined as the supply frequency of 45 Hz. The motor speed S was determined as the motor synchronous speed using the supply frequency and number of poles, giving a value of S=2*45/4=22.5 Hz.

The bearing fault characteristic frequencies, fb, were determined as: BPFI=5.91*22.5=133 Hz, BPFO=4.09*22.5=92 Hz, BSF=2.66*22.5=60 Hz and FTF=0.41*22.5=10 Hz. These values were for the first harmonic (k=1).

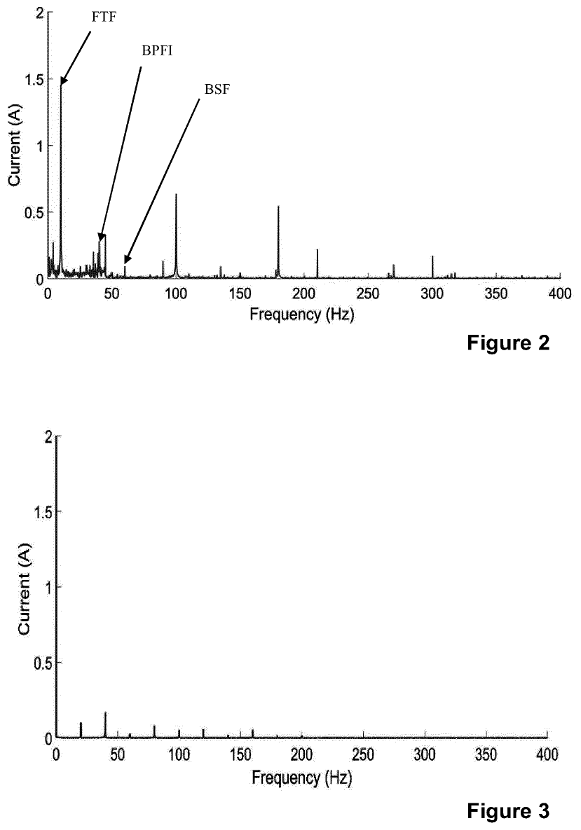

Data samples of current used by the motor was received from a current sensor provided at the motor. In the example, the data samples were processed by demodulating using Hilbert analysis and then FFT was applied. The resulting current spectrum is shown in FIG. 2.

The bearing fault characteristic frequencies, fb, when modulated onto the motor supply frequency fs, resulted in sideband frequencies, f_{fb} as follows (from Equation 5):

$$\begin{matrix}BPFI = \vert 45 \pm 133 \vert = 178 and 88 Hz \\ BPFO = \vert 45 \pm 92 \vert = 137 and 47 Hz \\ BSF = \vert 45 \pm 60 \vert = 105 and 15 Hz \\ FTF = \vert 45 \pm 10 \vert = 55 and 35 Hz\end{matrix}$$

Since the demodulation was applied using Hilbert analysis, the characteristic frequencies fb will appear in the current spectrum shown in FIG. 2 at a demodulated frequency fₕ according to Equation 7 as follows, where the _h suffix denotes BPFI, BPFO, BSF and FTF bearing fault characteristic frequencies after demodulation using Hilbert analysis:

$$\begin{matrix}BPFI\_h = \vert 178 - 45 \vert and \vert 88 - 45 \vert = 133 and 43 Hz \\ BPFO\_h = \vert 137 - 45 \vert and \vert 47 - 45 \vert = 92 and 2 Hz \\ BSF\_h = \vert 105 - 45 \vert and \vert 15 - 45 \vert = 60 and 30 Hz \\ FTF\_h = \vert 55 - 45 \vert and \vert 35 - 45 \vert = 10 Hz\end{matrix}$$

Peaks were identified, as indicating bearing fault at 10 Hz, 43 Hz, and 60 Hz corresponding to where FTF_h, BPFI_h and BSF_h i.e. modified characteristic frequencies using Hilbert, were expected. A counter value was set to 3 indicating the number of peaks identified as indicating bearing fault in an operation industrial motor (naturally developed fault). It will be appreciated that the above could be repeated for higher harmonics, eg k=2, 3 etc.

Later, the faulty bearing was replaced with a new one. The current spectrum of the same motor with the new bearing is shown in FIG. 3. It can be seen from FIG. 3 that the repaired motor is free from bearing fault, as no bearing fault characteristic frequencies were present. It will be appreciated by those skilled in the art that the method is easy to implement and effective in detecting bearing fault (point defects). In many cases, bearing with incipient faults could operate for months before actual failure. The notification provided by this method may, for example, be used by a maintenance team to schedule maintenance of the motor, thereby reducing downtime and reducing maintenance costs.

### Example 2

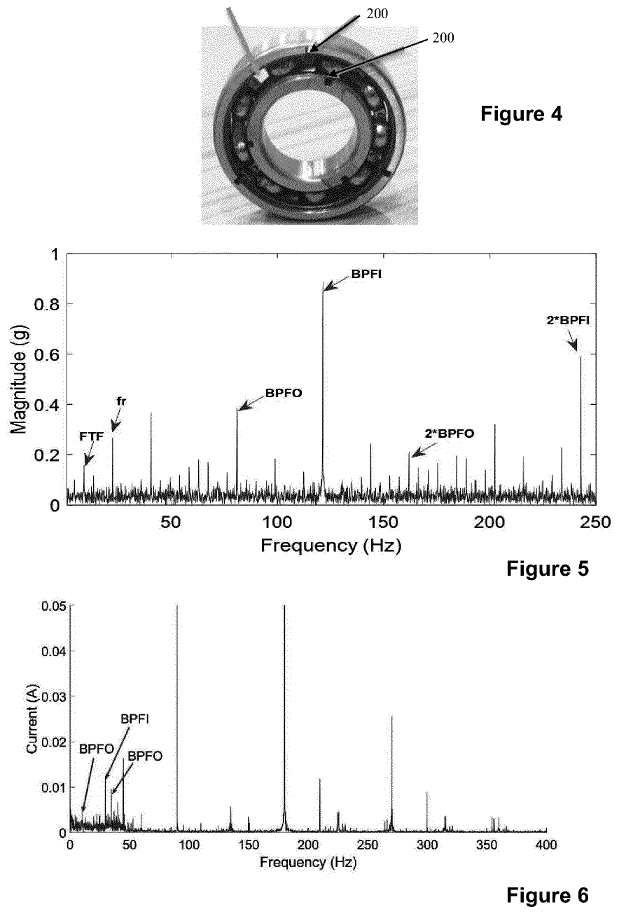

The method was also applied to a 3.75 KW induction motor with an artificially created bearing fault. The motor used bearings with model number 6206. Defects 200 were created in the inner and outer races using electrical discharge machining, as shown in FIG. 4.

Data samples of the current used by the motor were captured using a current sensor. For comparison, vibration data samples were also captured. The vibration spectrum of the motor with the faulty bearing is shown in FIG. 5. In vibration spectrum of FIG. 5, the bearing fault frequencies BPFI, BPFO and FTF are clearly visible. The amplitude of bearing fault frequencies BPFI, BPFO is higher than the motor speed, or fundamental rotational frequency, fr. Second harmonics (k=2) of BPFO and BPFI are also visible.

The current data samples were processing in the same manner as Example 1, that is demodulated and then FFT applied. The resulting current spectrum is shown in FIG. 6, and characteristic frequencies for BPFO and BPFI are clearly visible. This shows the effectiveness of the proposed method in detecting single point bearing fault.

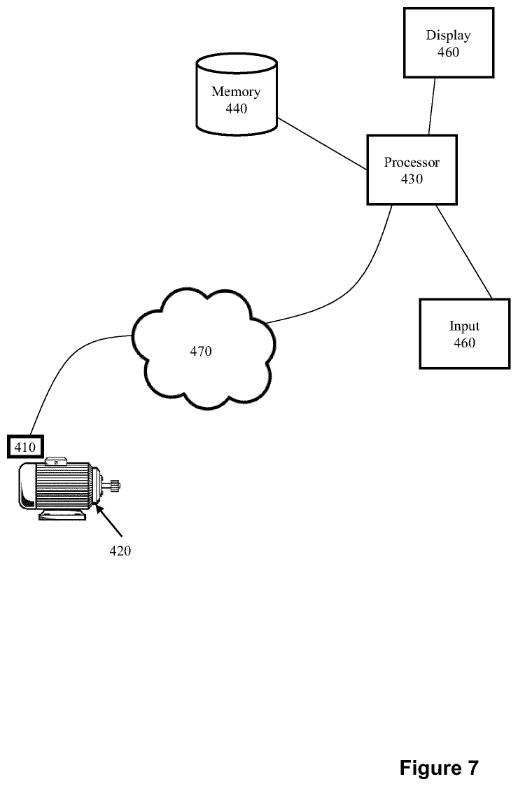

Referring now to FIG. 7, an apparatus 400 according to embodiments of the present disclosure is shown. The apparatus 400 comprises a current sensor 410 configured to measure current supplied to or used by a motor 420, at least one processor 430 (e.g., a central processing unit (CPU) and/or other suitable processor(s)) and at least one memory 440 (e.g., random access memory (RAM), read only memory (ROM), or the like). The apparatus 400 further comprises computer program code and various input/output devices 460, for example user input device/s (such as a keyboard, a keypad, a mouse, a microphone, a touch-sensitive display or the like), user output device/s (such as a display, a speaker, or the like), and storage devices (e.g., a tape drive, a floppy drive, a hard disk drive, a compact disk drive, non-volatile memory or the like)). The computer program code can be loaded into the memory 440 and executed by the processor 430 to perform the methods and functions as described herein. The processor 430 received data samples from the current sensor 410 via a network 470 in the implementation shown in FIG. 7. The network may be a wired or wireless network or networks in combination. In other implementations the current sensor 410 may be in direct communication with the processor 430, for instance via a direct wired connection. Computer program code (including associated data structures) can be stored on a computer readable storage medium, e.g., RAM memory, magnetic or optical drive or diskette, or the like. The computer readable storage medium may be a non-transitory storage medium in some implementations.

It will be appreciated that the step and functions depicted and described herein may be implemented in software (e.g., via implementation of software on one or more processors), for executing on a general purpose computer (e.g., via execution by one or more processors) so as to implement a special purpose computer, or the like and/or may be implemented in hardware (e.g., using a general purpose computer, one or more application specific integrated circuits (ASIC), and/or any other hardware equivalents).

A further embodiment is a computer program product comprising a computer readable storage medium having computer readable program code embodied therein, the computer readable program code being configured to implement one of the above methods when being loaded on a computer, a processor, or a programmable hardware component. In some embodiments, the computer readable storage medium is non-transitory.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as magnetic disks and magnetic tapes, hard drives, or optically readable digital data storage media. The embodiments are also intended to cover computers programmed to perform said steps of methods described herein or (field) programmable logic arrays ((F)PLAs) or (field) programmable gate arrays ((F)PGAs), programmed to perform said steps of the above-described methods.

When provided by a processor, the steps and functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

While aspects of the present disclosure have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present disclosure as determined based upon the claims and any equivalents thereof.

1. A computer-implemented method, comprising:
receiving current data samples from a current sensor configured to measure current drawn by a motor;
determining a frequency of the supply, fs;
determining a speed of the motor, S;
determining a characteristic frequency, fb, of a bearing fault;
processing the current data samples to obtain a frequency spectrum of the current;
determining whether the current frequency spectrum contains an indication of the bearing fault using the motor supply frequency, fs, and the characteristic frequency, fb, of the bearing fault; and
providing a fault notification according to the determined indication.

2. The method of claim 1, wherein the supply frequency, fs, is determined using a zero-crossing detector or by Fast Fourier Transform, FFT, analysis of the current data samples.

3. The method of claim 1, wherein the supply frequency, fs, is determined as a frequency of a power grid connected to the motor.

4. The method of claim 1, wherein the motor speed, S, is determined as the motor synchronous speed according to the number of poles of the motor and the supply frequency, fs.

5. The method of claim 1, wherein the coefficients related to the characteristic fault frequencies, fb, of the at least one bearing fault is determined from a look-up table.

6. The method of claim 1, wherein processing the current data samples comprises applying an FFT to the current data samples.

7. The method of claim 6, wherein processing the current data samples further comprises performing a Hilbert analysis to demodulate the supply frequency, fs, prior to applying the FFT.

8. The method of claim 1, wherein the current frequency spectrum is determined to contain an indication of a bearing fault if the current frequency spectrum contains a peak at sidebands of the supply frequency, fs, wherein the sidebands are offset from the supply frequency, fs, by the characteristic frequency, fb, of the bearing fault.

9. The method of claim 8, wherein the sideband is offset from the supply frequency, fs, by a harmonic of the bearing fault's characteristic frequency, fb.

10. The method of claim 1, wherein the current frequency spectrum is determined to contain an indication of a bearing fault if the current frequency spectrum contains a peak at demodulated sidebands, fₕ, of the supply frequency, fs, wherein the sidebands, fₕ, are offset from the supply frequency, fs, by the characteristic frequency, fb, of the bearing fault and demodulated by the supply frequency, fs.

11. The method of claim 8, wherein the sideband is within an offset range from the supply frequency, fs, the offset range defined by the characteristic fault frequencies, fb, of the bearing fault and upper and lower range limits.

12. The method of claim 1, wherein the steps of determining a bearing fault characteristic frequency, fb, and determining whether the current frequency spectrum contains an indication of the bearing fault are performed for at least two of the following bearing faults: fundamental train frequency/cage frequency, FTF; ball pass frequency of inner ring/inner race, BPFI; ball pass frequency of outer ring/outer race, BPFO, and ball spin frequency, BSF.

13. The method of claim 11, wherein providing a fault notification comprises providing a severe fault notification when the number of determined indications is greater than or equal to a threshold, providing an incipient fault notification when the number of determined indications is above 0 and below the threshold.

14. An apparatus comprising:
a current sensor configured to measure current supplied to or used by a motor; and,
a processor and a memory, the memory storing instructions which, when executed, cause the processor to perform the method of claim 1.

15. A computer readable storage medium storing instructions which,
when executed by a processor, cause the processor to perform the method of claim 1.

16. The method of claim 10, wherein the sideband is within an offset range from the supply frequency, fs, the offset range defined by the characteristic fault frequencies, fb, of the bearing fault and upper and lower range limits.
